(19) United States
(12) Patent Application Publication
(10) Pub. No.: US 2008/0176689 A1
(43) Pub. Date: Jul. 24, 2008

(54) ROTATING DISK WITH A PERIODICALLY CHANGING TOOTH-SPACE GEOMETRY

(75) Inventors: Frank Rettig, Herzogenaurach (DE); Roman Kern, Forchheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schaeffler KG, Herzogenaurach (DE)

(21) Appl. No.: 12/018,391

(22) Filed: Jan. 23, 2008

(30) Foreign Application Priority Data
Jan. 23, 2007 (DE) 102007003399.2

(51) Int. Cl. F16H 55/30; F16H 7/06

(52) U.S. Cl. 474/141; 474/148

(57) ABSTRACT

A rotating disk is provided, which can rotate by a rotational angle about a rotational axis (12) and has a number of teeth (20) arranged on a periphery of the rotating disk (10) and tooth spaces (22) located between the teeth, through whose middle runs a tooth-space middle line (30), and the rotating disk (10) has a periodically changing tooth-space geometry. The rotating disk (10) has a tip circle radius (24) that is constant. In addition, a drive device and a belt drive with a rotating disk (10) are provided.

### FIELD OF THE INVENTION

The present invention relates to a rotating disk, especially a rotating disk with a periodically changing tooth-space geometry. In addition, the present invention relates to a drive device with at least one rotating disk according to the invention and a belt drive with at least one rotating disk according to the invention.

### BACKGROUND

Drive systems based on force-transmitting endless elements, such as, e.g., belts or chains, and gears are widely used in industrial applications. Especially in internal combustion engines, such drive systems are used, e.g., for transmitting a torque from the crankshaft to the camshaft.

In addition to the camshaft and the crankshaft, other components, such as, e.g., water or fuel pumps, can also be driven by belts or chains. As a class for belt and chain drives, one speaks of so-called belt drives.

For such drive systems or belt drives, so-called belt-strand vibrations appear. Such belt-strand vibrations can involve transversal, longitudinal, or torsional vibrations in the force-transmitting endless element, with these vibrations being generated by cyclical motor movements. The cyclic excitation of the belt-strand vibration is usually realized due to a non-uniform drive element of the internal combustion engine.

In addition, a non-uniform load appears on toothed belts due to the vibrations. This non-uniform load leads to rips in the toothed belt and reduces the service life of the toothed belt.

Therefore, non-round gears have been proposed, in order to compensate for these belt-strand vibrations. Non-round gears are here understood to be gears, which do not have a circular peripheral cross section and for which the effective curve or the belt-wrap arc of the force-transmitting endless element is not circular.

Thus, the published specification DE 10 2004 048 629 A1 describes a non-round rotating disk of a control drive. The rotating disk here has a rotating disk radius, which depends functionally on the rotational angle and an average radius, wherein the average radius is selected so that a peripheral arc length of a rotating disk belt-wrap curve is equal to the product from the given distance of the midpoints of adjacent teeth and the number of teeth.

In addition, the utility model specification DE 202 20 367 U1 describes a synchronous drive device with a plurality of rotors, which are coupled to each other by a force-transmitting endless element, wherein one of the rotors has a non-circular profile with at least two projecting sections, which alternate with set-back sections, wherein the angular positions of the projecting and set-back sections of the non-circular profile and the degree of the eccentricity of the non-circular profile are selected so that the non-circular profile applies an opposite, variable, correcting torque to the force-transmitting endless element, which reduces or essentially cancels a variable load torque of a load structure.

The utility model specification DE 203 19 172 U1 describes a rotating component comprised of a rotor with several teeth arranged on the circumference of the rotor, wherein each tooth has a crown and a recess is located between each pair of teeth lying one next to the other, and the crowns of the teeth lie on a curved periphery, which forms the circumference of the rotor, and wherein the circumference of the rotor has a non-circular profile with at least two projecting regions, which alternate with set-back regions, wherein the distance of adjacent teeth between the midpoints of the crowns of each pair and the profile of the recess between each pair of adjacent teeth is essentially equal, and the distance between the midpoint of each crown and the axle of the rotor varies on the circumference, in order to achieve the mentioned non-circular profile.

For the space dimensions of such non-round rotating disks at their installation site, the greatest radius is always the decisive factor for allowing free rotation of the rotating disk. Thus, large space requirements are given even for rotating disks with a relatively greatly pronounced non-roundness.

Because the available volume in the engine compartments, especially for motor vehicles, is very limited, frequently problems in the arrangement of the rotating disks arise for non-round rotating disks of the state of the art.

### SUMMARY

The invention is based on the objective of providing a rotating disk, a drive device, or a belt drive, in which belt-strand vibrations can be compensated and an improved run-in or run-out behavior of the chain or the toothed belt is provided, wherein the space requirements of the rotating disk are minimized.

This object is met by a rotating disk, a drive device and a belt drive according to the invention.

The rotating disk according to the invention can rotate by a rotational angle about a rotational axis and has a number of teeth arranged on a periphery of the rotational disk and tooth spaces located between the teeth, through whose center a tooth-space middle line runs, wherein the rotational disk has a periodically changing tooth-space geometry and is characterized in that a tip circle radius of the rotating disk is constant.

The outer shape of the rotating disk is not the decisive factor for its effect and the gear ratio. Therefore, only the construction of the effective radius is decisive. Therefore, it is possible for the effective radius to have a periodically changing construction, wherein the radius of the tip circle remains constant.

Therefore, a circular peripheral shape of the rotating disk is produced and the space to be provided for its arrangement is minimized.

It can be provided that the periodically changing tooth-space geometry is formed, in that a reference circle radius of the rotating disk depends functionally on the rotational angle and a certain middle radius.

Thus, a circular outer shape of the rotating disk is provided, wherein the height of the teeth changes as a function of the rotational angle. A minimum tooth height is produced when the reference circle radius has a maximum. It can be provided that the maximum reference circle radius is then equal to the tip circle radius.

The traction element that is used, e.g., a roller or sleeve-type chain or a toothed belt, then engages more or less in the rotating disk according to the periodic change in the tooth height.

In addition, it can be provided that the periodically changing tooth-space geometry is formed, in that a tooth profile advances or retards a number of teeth (20) of the rotating disk (10) as a function of the rotational angle relative to a certain middle tooth profile.

Through the advancing or retarding tooth profile, it is possible to provide a rotating disk, whose gear ratio changes periodically, wherein the height of the teeth, however, remains constant. The traction element thus always engages uniformly in the rotating disk.

In addition, it can be provided that the tooth-space middle lines are each aligned essentially to the local curvature midpoint of the reference circle radius or the reference circle of the rotating disk.

It has been shown that the reason for high wear of the force-transmitting endless element is caused by large force spikes in the rotating disks of the state of the art, wherein these spikes are exerted by the toothed wheel teeth onto the endless element. The reason for this is the alignment and the profiling of the gears of the state of the art, which are designated below as circular gears.

In a circular gear, the tooth spaces located between the teeth are each symmetric to their corresponding tooth-space middle line. For circular gears, each tooth space middle line runs through the rotational axis or the midpoint of the circular gear. The section of the gear between two such tooth-space middle lines is called a sector in the scope of this description.

In a circular gear, all of the sectors are identical. By setting the sectors one after the other, a circular gear is obtained. Here, the tooth spaces feature a continuous surface without inconsistencies provided with tangential transitions between the sectors.

In non-circular or non-round gears with a functionally dependent reference circle radius, for the design it was similarly fixed that all of the tooth-space middle lines must run through the rotational axis of the gear. For such gears, however, sectors that are not simply identical can be set one after the other. Instead, the sectors must be deformed by a certain degree, in order to set the individual sectors one after the other along the non-circular periphery.

The tooth-space contours are then deformed, however, so that they generate an increased load in the tooth base of the force-transmitting endless element. In addition, increased wear occurs on such contours.

Therefore, the tooth-space middle lines of a rotating disk of the present invention cannot all be directed toward the rotational axis, but instead each is directed essentially toward the local curvature midpoint of the reference circle of the rotating disk, i.e., they are perpendicular to the contours of the reference circle. The tooth-space middle lines then usually no longer run through the rotational axis. The flank contours of a tooth are produced from the shape of adjacent tooth spaces. The tip contours of the tooth are produced from the constant tip circle.

Through this alignment of the tooth-space middle lines to the corresponding local curvature midpoints, tooth-space geometries are generated with continuous transitions between the sectors in the tooth spaces. In addition, in this way the problem of increased wear is prevented. The run-in and run-off of the force-transmitting endless element are performed with reduced friction and wear, because the pressure due to the force transmission from the teeth to the force-transmitting endless element is now uniformly distributed and force spikes are prevented.

It can be provided that the tooth-space middle lines are aligned so that a circular surface concentric to the rotational disk is not intersected by the tooth-space symmetry axes, which do not run through the rotational axis. The circular surface can have a diameter of approximately 0.1 mm to approximately 20 mm and especially a diameter of approximately 0.5 mm to approximately 6 mm.

The profile of a tooth space can be constructed symmetrically or asymmetrically to the tooth-space middle line.

In one embodiment of the invention, it can be provided that the rotational-disk radius can be expressed by a harmonic expansion of the following form:

$$r ( t ) = {r}_{middle} + {\sum }_{i} δ {r}_{i} cos ( {n}_{i} t + {ϕ}_{i} ) ,$$

wherein, here, r_{middle} is the average radius, δrᵢ is a non-roundness amplitude, nᵢ is a number of elevations, φᵢ is a phase position, and t is an incremental parameter composed of an interval from 0 to 2π. The average radius is here selected suitably as a function of the other parameters, so that a desired length of the belt-wrap curve of the rotating disk is produced. The number of elevations is also designated as the order. As can be seen, several angle-dependent interference elements of various orders can be superimposed onto the average radius. If there are no interference elements, a circular rotating disk is produced. Accordingly, it is provided that at least one interference element is always provided.

If each parameter δrᵢ is set equal to zero, one similarly obtains a circular rotating disk. Accordingly, it is provided according to the invention that each parameter δrᵢ is not equal to zero.

A drive device according to the invention includes at least two rotating disks and a force-transmitting endless element for transmitting a moment between the rotating disks and at least one of the rotating disks is a rotating disk according to the invention. In this way, increased wear on the force-transmitting endless element is prevented also for the drive device according to the invention.

In addition, the drive device according to the invention can be constructed for use in a motor vehicle.

Alternatively, the drive device according to the invention can be constructed for use in aircraft.

In one embodiment, the drive device according to the invention is a synchronous drive device.

The belt drive according to the invention includes at least two rotating disks and a force-transmitting endless element for transmitting a moment between the rotating disks and at least one of the rotating disks is a rotating disk according to the invention. In this way, increased wear of the force-transmitting endless element is prevented also for the belt drive according to the invention.

Additional advantages and constructions of the invention result from the description and the enclosed drawing.

It is understood that the previously mentioned features and the features still to be explained below can be used not only in the specified combination, but also in other combinations or alone, without leaving the scope of the present invention.

### BRIEF DESCRIPTION OF THE DRAWINGS

The invention is explained in more detail below with reference to a preferred embodiment. Shown in the associated drawing are:

FIG. 1 is a view of a first embodiment of a rotating disk according to the invention.

FIG. 2 is a view of a second embodiment of a rotating disk according to the invention.

FIGS. 2A and 2B are enlarged details taken from FIG. 2.

### DETAILED DESCRIPTION OF THE PREFERRED EMBODIMENTS

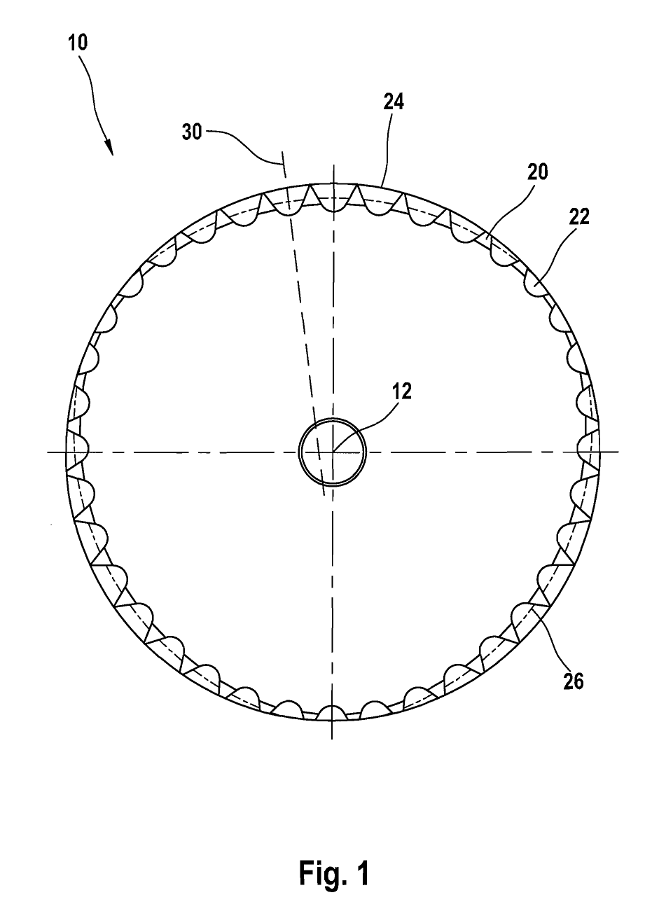

FIG. 1 shows a first embodiment of a rotating disk 10 according to the invention.

The rotating disk 10 can rotate by a rotational angle about a rotational axis 12 and has a number of teeth 20 arranged on a periphery of the rotating disk 10, with tooth spaces 22 located between the teeth 20, through whose middle a tooth-space middle line 30 runs.

The illustrated rotating disk 10 has a periodically changing tooth-space geometry, such that the reference circle radius 26 of the rotating disk functionally depends on the rotational angle and a certain average radius. In the illustrated example, the reference circle radius 26 has three maximums or minimums.

The tip circle radius 24 of the rotating disk 10 is constant.

This similarly produces a height of the teeth 20 that is dependent on the rotational angle. Accordingly, the height of the teeth 20 is always at a minimum when the reference circle radius 26 is at a maximum and corresponds to the tip circle radius 24. Accordingly, a maximum tooth height is produced for a minimum reference circle radius.

Depending on the height of the teeth 20, possible traction means, e.g., a roller or sleeve-type chain or a toothed belt, engage to a differing degree into the rotating disk 10.

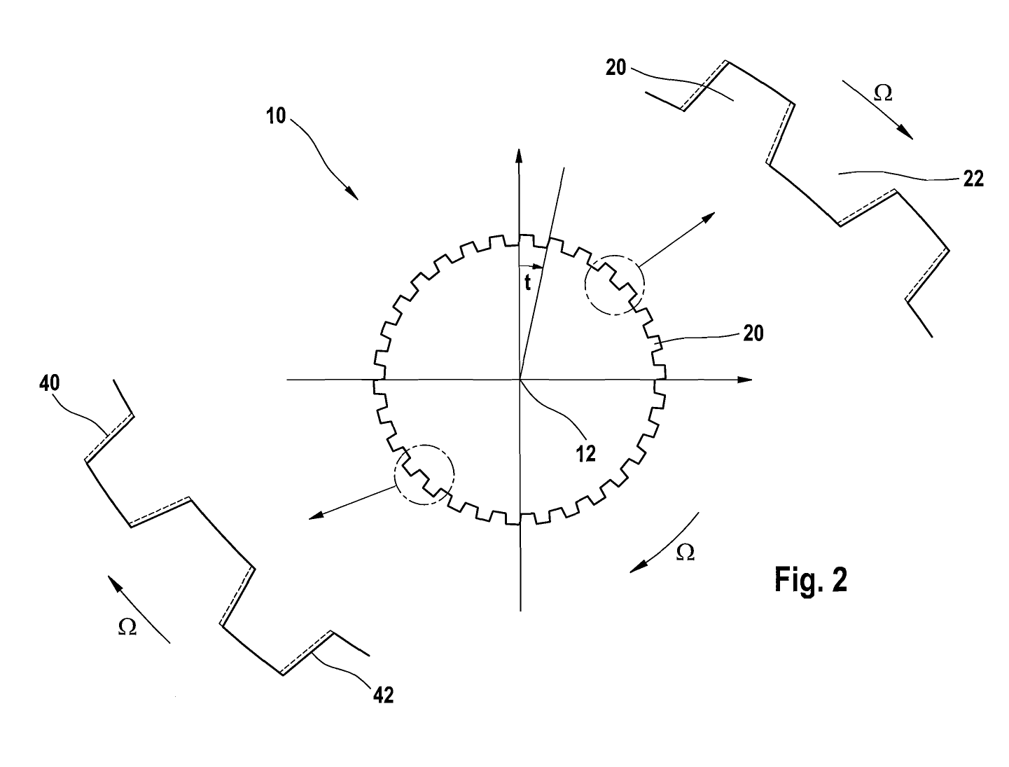

FIG. 2 shows a second embodiment of a rotating disk 10 according to the invention.

In addition, in two enlarged views indicated as FIGS. 2A and 2B, a profile without periodic changes or a reference profile 40 is shown with dashed lines and an actual, periodically changing profile 42 is shown with continuous lines.

As can be seen in FIG. 2, the rotating disk 10 has a constant tip circle radius and also a constant reference circle radius 26. A periodically changing gear ratio of the rotating disk 10 is provided, in that the actual profile 42 oscillates around the reference profile 40, i.e., advances or retards relative to the reference profile 40 as a function of a rotational angle t.

From the direction of rotation Ω it results that the actual profile 42 is advanced relative to the reference profile 40 in FIG. 2A and is retarded relative to the reference profile 40 in FIG. 2B.

Through the rotating disks according to the invention described above, it is possible to prepare a rotating disk, in which belt-strand vibrations can be equalized and which provides an improved run-in or run-out behavior of traction element, wherein the space requirements of the rotating disk 10 are minimized.

The rotating disk 10 according to the invention is used preferably in a belt drive. The belt drive is advantageously constructed for use in a motor vehicle or in aircraft. The rotating disk 10 according to the invention, however, also can be used independent of these applications, e.g., also in textile or office machines.

### LIST OF REFERENCE SYMBOLS

10 Rotating disk
12 Rotational axis
20 Teeth
22 Tooth spaces
24 Tip circle radius
26 Reference circle radius
30 Tooth-space middle lines
40 Reference profile
42 Actual profile
Ω Direction of rotation
t Rotational angle

1. Rotating disk, which can rotate by a rotational angle about a rotational axis, comprising a number of teeth arranged on a periphery of the rotating disk and tooth spaces located between the teeth, through whose middle a tooth-space middle line runs, wherein the rotating disk has a periodically changing tooth-space geometry and a tip circle radius of the rotating disk is constant.

2. Rotating disk according to claim 1, wherein the periodically changing tooth-space geometry is formed in that a reference circle radius of the rotating disk is functionally dependent on the rotational angle and a certain average radius.

3. Rotating disk according to claim 1, wherein the periodically changing tooth-space geometry is formed in that a tooth profile of the number of teeth of the rotating disk advances or retards as a function of the rotational angle relative to a certain middle tooth profile.

4. Rotating disk according to claim 1, wherein the tooth-space middle lines are aligned generally toward a local curvature midpoint of the reference circle radius of the rotating disk.

5. Rotating disk according to claim 4, wherein the rotating disk has a concentric circular surface, which is not intersected by the tooth-space middle lines not running through the rotational axis.

6. Rotating disk according to claim 2, wherein the reference circle radius can be expressed by a harmonic expansion of the following form:
$$r ( t ) = {r}_{middle} + {\sum }_{i} δ {r}_{i} cos ( {n}_{i} t + {ϕ}_{i} )$$
wherein, here:
r_{middle}=average radius,
δrᵢ a non-roundness amplitude,
nᵢ number of elevations,
φᵢ a phase position, and
t=an incremental parameter composed of an interval from 0 to 2π.

7. Drive device comprising at least two rotating disks and a force-transmitting endless element for transmitting a force between the rotating disks, at least one of the rotating disks is a rotating disk having a number of teeth arranged on a periphery of the at least one of the rotating disks and tooth spaces located between the teeth, through whose middle a tooth-space middle line runs, wherein the at least one of the rotating disks has a periodically changing tooth-space geometry and a tip circle radius of the at least one of the rotating disks is constant.

8. Drive device according to claim 7, wherein the drive device is in a motor vehicle.

9. Drive device according to claim 7, wherein the drive device is in an aircraft.

10. Belt drive comprising at least two rotating disks and a force-transmitting endless element for transmitting a force between the rotating disks, at least one of the rotating disks is a rotating disk having a number of teeth arranged on a periphery of the at least one of the rotating disks and tooth spaces located between the teeth, through whose middle a tooth-space middle line runs, wherein the at least one of the rotating disks has a periodically changing tooth-space geometry and a tip circle radius of the at least one of the rotating disks is constant.
